(19) United States
(12) Patent Application Publication
(10) Pub. No.: US 2010/0211332 A1
(43) Pub. Date: Aug. 19, 2010

(54) GAS FLOW METER READER

(76) Inventors: Philip M. Isaac, Lloydminster (CA); Kevin D. Clarke, Lloydminster (CA)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(21) Appl. No.: 12/707,592

(22) Filed: Feb. 17, 2010

(30) Foreign Application Priority Data
Feb. 17, 2009 (CA) 2,655,591

(51) Int. Cl. G01F 1/38

(52) U.S. Cl. 702/47

(57) ABSTRACT

A gas flow meter reader has a first shaft that rotates in response to a first gas pressure from gas in a gas line, and a second shaft that rotates in response to a second gas pressure from the gas line. Each of the first and second shafts are connected to an inclinometer that converts the rotation of each of the first and second shafts into an electric signal. A processor is electrically connected to the inclinometers for processing the electric signals to output a flow rate of the gas in the gas line.

### FIELD

A gas flow meter reader with a tilt sensor.

### BACKGROUND

The most common method of gas flow measurement, such as for measuring the flow in a gas pipeline, is by using an orifice plate to introduce a flow restriction. The pressure on either side of the orifice plate and the temperature of the gas is measured. The pressure and temperature measurements are output onto a chart recorder, sometimes referred to as a “dri-flo” meter that uses a circular graph. The circular graph is removed periodically to be analyzed. The tracings on the graph, along with the dimensions of the pipe, the orifice plate, etc. are then used to determine measurements related to the flow.

U.S. Pat. No. 3,980,865 (Messer et al.) describes a meter reader that encodes the gas pressure measured by a mechanical meter.

### SUMMARY

There is provided a gas flow meter reader, comprising a first shaft that rotates in response to a first gas pressure from gas in a gas line, and a second shaft that rotates in response to a second gas pressure from the gas line. Each of the first and second shafts are connected to an inclinometer. The inclinometers convert the rotation of each of the first and second shafts into an electric signal. A processor is electrically connected to the inclinometers for processing the electric signals to output a flow rate of the gas in the gas line.

### BRIEF DESCRIPTION OF THE DRAWINGS

These and other features will become more apparent from the following description in which reference is made to the appended drawings, the drawings are for the purpose of illustration only and are not intended to be in any way limiting, wherein:

FIG. 1 is a schematic view of a gas flow meter reader.

FIG. 2 is a schematic view of inclinometer chips.

FIG. 3 is a schematic view of an example circuit layout.

### DETAILED DESCRIPTION

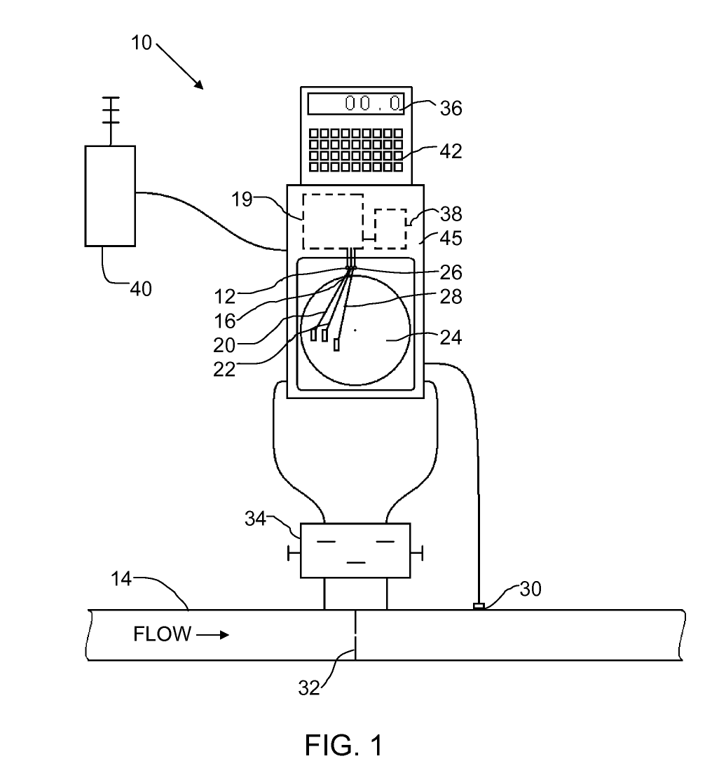

A gas flow meter reader generally identified by reference numeral 10 will now be described with reference to FIG. 1 through 3.

### Structure and Relationship of Parts:

Referring to FIG. 1, gas flow meter reader 10 has a first shaft 12 that rotates in response to a first gas pressure from gas in a gas line 14, and a second shaft 16 that rotates in response to a second gas pressure from gas line 14. Arms 20 and 22 are preferably mounted to first shaft 12 and second shaft 16. Each arm 20 and 22 produces a trace on graph paper 24 that is representative of the respective gas pressure. For example, first arm 20 may trace the static pressure related to the pressure downstream of an orifice plate 32 in gas line 14, while second arm 22 traces a differential pressure across orifice plate 32. Orifice plate 32 is a common plate, such as a plate with a single hole that has a bevelled edge on the downstream side. This is how the measurements are commonly made with traditional chart recorders, and would allow the same bellows and valve manifold 34 to be used if meter reader 10 were to be retrofitted into an existing installation. It will be understood, of course, that readings may also be made using other measurements, such as temperature.

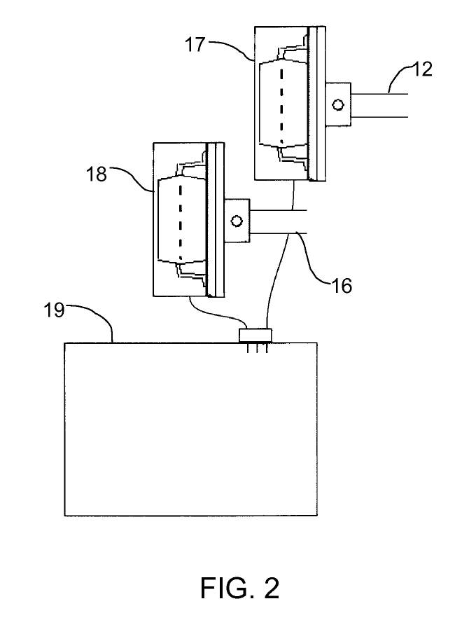

Referring to FIG. 2, shafts 12 and 16 are each connected to an inclinometer 17 and 18. Inclinometers 17 and 18 convert the rotation of each of the first and second shafts 12 and 16 into an electric signal. A processor 19 is electrically connected to inclinometers 12 and 16 for processing the electric signals to output a flow rate of the gas in gas line 14. Processor 19 may output the flow rate to, for example, a digital display 36, a memory unit 38, a communications network 40, etc. In one embodiment, processor 19 may be connected to a new or existing SCADA (Supervisory Control And Data Acquisition) system. Processor 19 may also be adapted to receive data from an input source, such as a keypad 42, which would allow a user to configure parameters such as orifice plate size, time, date, etc. or to access historical data.

Referring to FIG. 2, in situations where temperature is used in the calculations, a temperature sensor is included, such as an RTD 30. If it is desired to plot the temperature on graph paper 24 as well, third shaft 26 may be included with a third arm 28 that rotates in response to a change in the temperature as sensed by RTD 30. It will be understood that the temperature may be sensed using a any other suitable means for measuring the temperature as well. RTD 30 transmits its data to processor 19. The flow volume can then be calculated with known formulas using the differential pressure, static pressure, temperature, and the sizes of gas line 14 and the orifice in orifice plate 32. In one example, the pressure before orifice plate 32 may be 102 psi, and the pressure after orifice plate 32 may be 100 psi. Thus, the differential pressure would be read as 2 psi, and the static pressure would be read at 100 psi

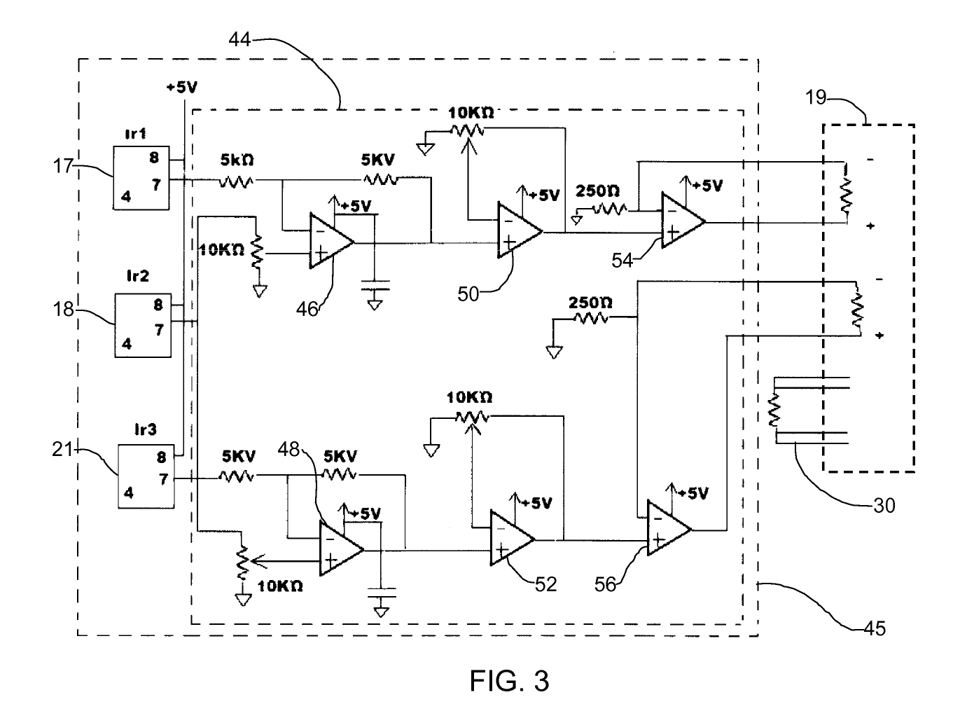

It will be understood that the processing steps represented by processor 19 may be performed by different processing components. For example, some signal processing may be done within the chart recorder housing 45. Referring to FIG. 3, an example of such a calculation circuit 44 is shown. Circuit 44 is designed to convert a voltage signal to a standard 4-20 mA signal, which can then be used universally by many instruments and controls in industry. In this example, inclinometers 17, 18 and 21 are used to sense differential pressure, a movement of the entire chart recorder to make any necessary bias corrections, and static pressure, respectively. Temperature is sensed by RTD 30. The values for resistive elements and power supplies shown are selected to produce the desired output. Elements 46 and 48 set the bias, while elements 50 and 52 amplify the signals to achieve full span. Elements 54 and 56 convert the voltage signal to a 4-20 mA signal. These signals are then transmitted for further processing, for example by processor 19, which may be part of a SCADA system, a standalone system, or may also be included in chart recorder housing 45.

### Operation:

Referring to FIG. 1, gas flow meter reader 10 is assembled as described above, with arms 20, 22, and 28 tracing the static pressure, differential pressure, and temperature on graph paper 24. Referring to FIG. 2, inclinometers 17 and 18 are connected to shafts 12 and 16 to convert the mechanical movement of shafts 12 and 16 into electrical signals. Referring to FIG. 3, these electrical signals are received by circuit 44, which converts the signal to a usable signal, such as a signal between 4-20 mA. This is then transmitted to processor 19 with measurements from an RTD 30, if used.

Referring to FIG. 1, gas flow meter reader 10 may be installed as a new installation, or as part of a retrofit to update existing meter readers. As part of a retrofit, it may be possible to disconnect the lines between the existing meter reader and RTD 30 and valve manifold 34, and reconnect these lines to gas flow meter reader 10, which allows the retrofit to be accomplished with relatively low cost and difficulty. There would be no need to intrude on gas line 14 or interrupt the gas flow during the installation process.

### Advantages:

Because the components are similar between the gas line and the shaft, gas flow meter reader 10 may be used to replace existing readers in a more economical manner than having to introduce new pressure sensors, since the existing bellows and manifold may be used.

While in existing meter readers, the traces must be analyzed to obtain data, gas flow meter reader 10 can be designed to give real-time measurements, with data stored in memory for a period of time, for example, one year, or it may also be transmitted to a Remote Terminal Unit (RTU).

In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be one and only one of the elements.

The following claims are to be understood to include what is specifically illustrated and described above, what is conceptually equivalent, and what can be obviously substituted. Those skilled in the art will appreciate that various adaptations and modifications of the described embodiments can be configured without departing from the scope of the claims. The illustrated embodiments have been set forth only as examples and should not be taken as limiting the invention. It is to be understood that, within the scope of the following claims, the invention may be practiced other than as specifically illustrated and described.

What is claimed is:

1. A gas flow meter reader, comprising:
a first shaft that rotates in response to a first gas pressure from gas in a gas line;
a second shaft that rotates in response to a second gas pressure from gas in the gas line;
each of the first and second shafts being connected to an inclinometer, the inclinometers converting the rotation of each of the first and second shafts into an electric signal; and
a processor electrically connected to the inclinometers for processing the electric signals to output a flow rate of the gas in the gas line.

2. The gas flow meter reader of claim 1, wherein an arm is mounted to each of the first shaft and second shaft, each arm tracing a graph on a graph paper representative of the respective gas pressure.

3. The gas flow meter reader of claim 1, further comprising a third shaft that rotates in response to a gas temperature in the gas line.

4. The gas flow meter reader of claim 3, where the third shaft is connected to an inclinometer that is electrically connected to the processor.

5. The gas flow meter reader of claim 1, wherein the first gas pressure relates to a static pressure, and the second gas pressure relates to a differential pressure across an orifice plate in the gas line.

6. The gas flow meter reader of claim 1, wherein the processor outputs the flow rate to at least one of a digital display, a memory unit, and a communications network.
